(19) United States
(12) Patent Application Publication
(10) Pub. No.: US 2026/0025012 A1
(43) Pub. Date: Jan. 22, 2026

(54) MODULAR POWER SUPPLY FOR A BATTERY PACK OF A POWER TOOL

(71) Applicant: Milwaukee Electric Tool Corporation, Brookfield, WI (US)

(72) Inventors: Maxwell A. Casper, Menomonee Falls, WI (US); Richard A. Behnke, Milwaukee, WI (US); Benjamin Shaske, Pawaukee, WI (US); Tyler Graham, Brookfield, WI (US); Gavin DeGroot, Milwaukee, WI (US)

(21) Appl. No.: 19/264,483

(22) Filed: Jul. 9, 2025

Related U.S. Application Data
(60) Provisional application No. 63/671,845, filed on Jul. 16, 2024.
(60) Provisional application No. 63/680,143, filed on Aug. 7, 2024.

(51) Int. Cl. H02J 7/00; H01M 10/44; H01M 50/204; H01M 50/247

(52) U.S. Cl. CPC H02J 7/0024; H01M 10/441; H01M 50/247; H02J 7/0045; H02J 7/0047; H02J 7/0063; H02J 7/00712; H01M 50/204

(57) ABSTRACT

Power packs configured to supply power to a common load are provided. A power pack includes a first power source; a second power source; at least one adapter configured to receive the common load and electrically couple the common load to at least one of the first power source or the second power source for supplying power to the common load; a tether interface electrically coupled to the at least one adapter, the first power source, and the second power source and configured to arrange the first power source and the second power source in series or in parallel; and a control circuit comprising at least one controller for performing a plurality of operations.

### CROSS-REFERENCE TO RELATED APPLICATIONS

This application is a non-provisional application claiming the benefit of priority under 35 U.S.C. § 119 (e) to U.S. Provisional Application No. 63/671,845, filed on Jul. 16, 2024, and U.S. Provisional Application No. 63/680,143, filed on Aug. 7, 2024, which are hereby incorporated by reference in their entirety.

### FIELD

The present disclosure relates generally to power tools, and more particularly to a modular power supply for a battery pack of a power tool.

### BACKGROUND

Portable battery-powered tools may rely on a rechargeable battery pack for power. The battery pack can connect directly to the tool (i.e., inserted into the tool) or may be configured as a self-contained unit that is carried by a user and electrically tethered to the tool, such as a backpack or carry-on battery pack. As the use and convenience of portable tools grows, so does the demand for increased power density and efficiency from these battery packs to provide more power and a longer run time for the tool.

In certain instances, the battery packs are intended to work with only certain tools that use a common battery interface. However, some tools have different voltage requirements and may require the purchase of additional battery packs that are compatible with such voltage requirements. Accordingly, improved battery packs are desired in the art. In particular, battery packs which provide a range of voltage outputs for meeting voltage requirements of various power tools would be advantageous.

### BRIEF DESCRIPTION

Aspects and advantages of the present disclosure will be set forth in part in the following description, or may be obvious from the description, or may be learned through practice of the technology.

In accordance with one embodiment, a power pack configured to supply power to a common load is provided. The power pack includes a first power source; a second power source; at least one adapter configured to receive the common load and electrically couple the common load to at least one of the first power source or the second power source for supplying power to the common load; a tether interface electrically coupled to the at least one adapter, the first power source, and the second power source and configured to arrange the first power source and the second power source in series or in parallel; and a control circuit comprising at least one controller for performing a plurality of operations. The plurality of operations include detecting a voltage requirement of the common load from the at least one adapter, determining whether to connect the first power source or the second power source in series or in parallel based on the voltage requirement, connecting the first power source and the second power source in series via the tether interface when the voltage requirement exceeds a voltage threshold, and connecting the first power source and the second power source in parallel via the tether interface when the voltage requirement is less than or equal to the voltage threshold.

In accordance with another embodiment, a power pack configured to supply power to a common load is provided. The power pack includes a plurality of batteries; at least one adapter configured to receive the common load and electrically couple the common load to at least one of the plurality of batteries for supplying power to the common load; a tether interface electrically coupled between the at least one adapter and the plurality of batteries and configured to arrange one or more of the plurality of batteries in series; and a control circuit comprising at least one controller for performing a plurality of operations. The plurality of operations include detecting a voltage requirement of the common load from the at least one adapter, connecting at least two of the plurality of batteries in series via the tether interface based on the voltage requirement.

In accordance with yet another embodiment, a method of supplying power to a common load from a power pack is provided. The method includes detecting, via at least one adapter configured to receive the common load, a voltage requirement for the common load from the at least one adapter; determining, via a control circuit, whether to connect a plurality of batteries in parallel or in series based on the voltage requirement; and connecting, via a tether interface, the plurality of batteries in series or in parallel based on the voltage requirement.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a power pack in accordance with embodiments of the present disclosure;

FIG. 2 is a schematic diagram of a system for supplying power to a common load in accordance with embodiments of the present disclosure;

FIG. 3 is a schematic diagram of a system for supplying power to a common load in accordance with embodiments of the present disclosure;

FIG. 4 is a schematic diagram of a system for supplying power to a common load in accordance with embodiments of the present disclosure;

FIG. 5 is a schematic diagram of a battery pack for supplying power to a common load in accordance with embodiments of the present disclosure; and

FIG. 6 is a flow diagram of a method of supplying power to a common load in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be constr18 volyued as a critical, required, or essential feature of any or all the claims.

In general, power packs and battery packs for supplying power to power tools, such as handheld power tools, may have varying voltage requirements. For example, a user may be required to purchase a variety of battery packs in order to power a variety of power tools. Accordingly, a modular battery pack for supplying a range of voltages to various types of power tools is desirable.

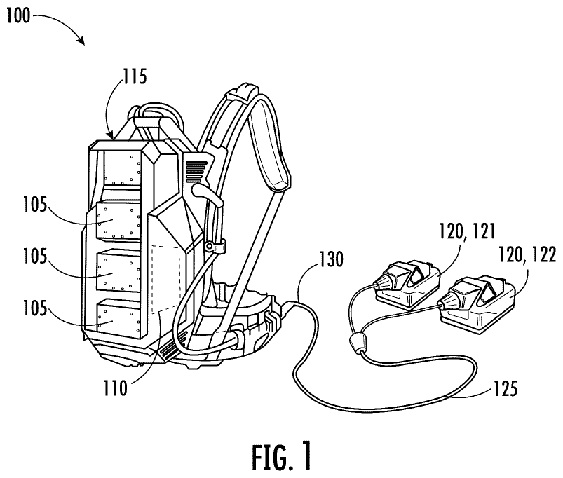

Referring now to the drawings, FIG. 1 illustrates a perspective view of a power pack 100 in accordance with embodiments of the present disclosure. The power pack 100 includes at least one power source 105 and at least one controller 110. The power source(s) 105 may include a plurality of batteries. The power pack 100 may be configured as a backpack 115 configured to be worn by a user. Accordingly, the power source(s) 105 and the controller(s) 110 may be disposed in the backpack 115.

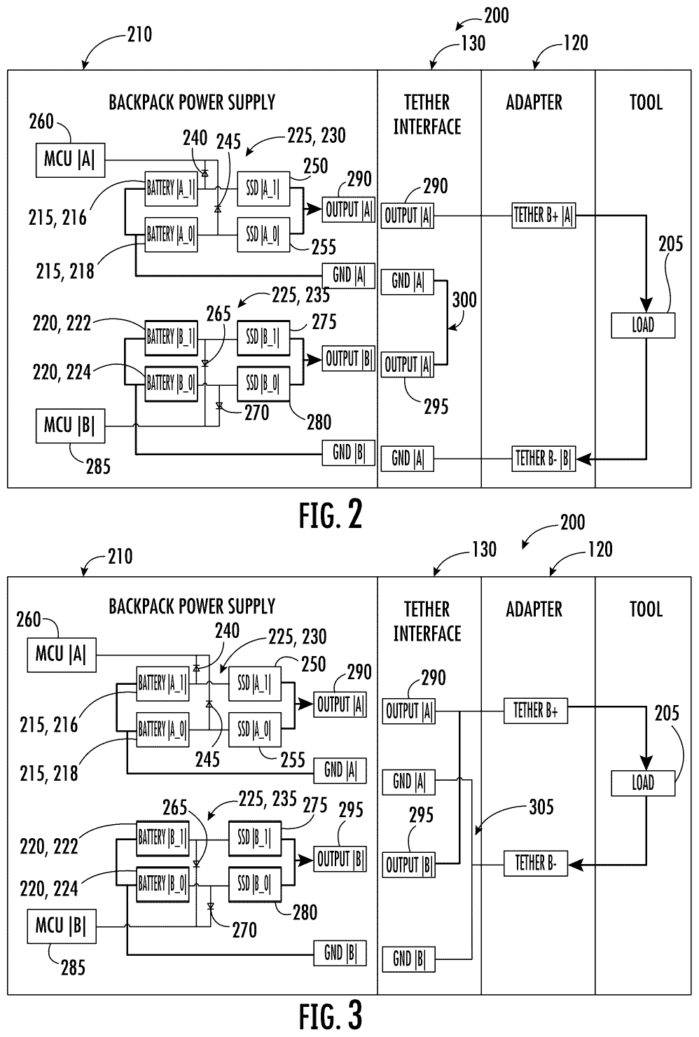

The power pack 100 also includes at least one adapter 120 electrically coupled to the power source(s) 105 via a tether 125. The tether 125 may include a cable or wire electrically coupling the adapter(s) 120 to the power source(s) 105 of the backpack 115. The adapter(s) 120 is configured to receive a common load 205 (shown in FIGS. 2-4), such as a power tool, and electrically couple the common load to the power source(s) 105 for supplying power from the power source(s) 105 to the common load.

As shown in FIG. 1, the adapter(s) 120 may include a first adapter 121 and a second adapter 122. One or both of the first adapter 121 and the second adapter are configured to be electrically coupled to the common load. In some example embodiments, the first adapter 121 may be configured to be electrically coupled to a first load type and the second adapter 122 may be configured to be coupled to a second load type. The first load type and the second load type may be different types of power tools having different voltage requirements. Moreover, the first adapter 121 may be capable of mechanically engaging the first load type and incapable of mechanically engaging the second load type. Accordingly, in an embodiment, the first adapter 121 may only electrically couple the first load type to the power source(s) 105. Similarly, the second adapter 122 may be capable of mechanically engaging the second load type and incapable of mechanically engaging the first load type such that the second adapter 122 may only electrically couple the second load type to the power source(s) 105.

Additionally, as shown in FIG. 1, the power pack 100 includes a tether interface 130 electrically coupled to the adapter(s) 120 and the power source(s) 105. More specifically, the tether interface 130 may be electrically coupled between the power source(s) 105 and the tether 125. The tether interface 130 may be configured to arrange the plurality of batteries of the power source(s) 105 in parallel or in series, as will be described in greater detail herein. In other example embodiments, the plurality of batteries of the power source(s) 105 may be arranged in parallel or in series by an electrical switch. For example, the electrical switch may include one or more N-channel MOSFETs.

Referring now to FIG. 2, a schematic diagram of a system 200 for supplying power to a common load 205 in accordance with embodiments of the present disclosure is illustrated. In at least one example embodiment, the common load 205 may be a power tool, such as any suitable handheld power tool. Moreover, as shown, the system 200 includes a battery pack 210. The battery pack 210 may include the power source(s) 105. For example, as shown, the battery pack 210 includes a first power source 215 having a first battery 216 and a second battery 218 and a second power source 220 having a third battery 222 and a fourth battery 224 that are together electrically coupled to the common load 205 via the tether interface 130 and the adapter(s) 120. The first battery 216 and the second battery 218 may be connected in parallel, and the third battery 222 and the fourth battery 224 may be connected in parallel.

In at least one example embodiment, the battery pack 210 includes at least one control circuit 225 electrically coupled to each of the batteries 216, 218, 222, 224. For example, the at least one control circuit 225 includes a first circuit 230 electrically coupled to the first battery 216 and the second battery 218 of the first power source 215 and a second circuit 235 electrically coupled to the third battery 222 and the fourth battery 224 of the second power source 220.

The first circuit 230 includes a first diode 240, a second diode 245, a first driver 250, a second driver 255, and a first controller 260. The first controller 260 may be a controller of the at least one controller 110 discussed with respect to FIG. 1. The first driver 250 and the second driver 255 may each be implemented with a solid state disconnect (SSD) controlled by the first controller 260. The first controller 260 is configured to provide a signal to one or both of the first driver 250 and the second driver 255 for controlling a first output 290 from one or both of the first battery 216 and the second battery 218.

The second circuit 235 includes a third diode 265, a fourth diode 270, a third driver 275, a fourth driver 280, and a second controller 285. The second controller 285 may also be a controller of the at least one controller 110 discussed with respect to FIG. 1. The third driver 275 and the fourth driver 280 may each be implemented with a solid state disconnect (SSD) controlled by the second controller 285. The second controller 285 is configured to provide a signal to one or both of the third driver 275 and the fourth driver 280 for controlling a second output 295 from one or both of the third battery 222 and the fourth battery 224.

Still referring to FIG. 2, the tether interface 130 is configured to arrange the first power source 215 and the second power source 220 in series or in parallel based on a voltage requirement of the common load 205. In at least one example embodiment, the adapter(s) 120 receives the common load 205 and the at least one control circuit 225 is configured to detect a voltage requirement of the common load 205 from the adapter(s) 120. The at least one control circuit 225 also determines whether to connect the first power source 215 and the second power source 220 in series or in parallel based on the voltage requirement. The tether interface 130 is configured to connect the first power source 215 and the second power source 220 in series, such as via a series connection 300, based on the voltage requirement exceeding a voltage threshold.

In at least one example embodiment, the voltage threshold is about 18 volts. In such embodiments, each of the batteries 216, 218, 222, and 224 may include 18-volt batteries. Accordingly, based on the voltage requirement exceeding the voltage threshold, the first power source 215 and the second power source 220 are connected in series by the tether interface 130 to achieve a higher voltage output and meet the voltage requirement of the common load 205.

Referring now to FIG. 3, a schematic diagram of the system 200 for supplying power to the common load 205 in accordance with embodiments of the present disclosure is illustrated. More particularly, FIG. 3 illustrates the first power source 215 and the second power source 220 connected in parallel.

As discussed above with respect to FIG. 2, the control circuit 225 determines whether to connect the first power source 215 and the second power source 220 in series or in parallel based on the voltage requirement. With reference to FIG. 3, the tether interface 130 is configured to connect the first power source 215 and the second power source 220 in parallel, such as via a parallel connection 305, based on the voltage requirement being less than or equal to the voltage threshold. For example, in embodiments where the voltage threshold is 18 volts and the batteries 216, 218, 222, and 224 include 18-volt batteries, the first power source 215 and the second power source 220 may be connected in parallel by the tether interface 130 to deliver the voltage requirement to the common load 205.

In other example embodiments, the voltage threshold may be greater than 18 volts, such as 36 volts or 72 volts. Moreover, in such embodiments, the common load 205 may include one or more of an 18-volt power tool, a 36-volt power tool, and a 72-volt power tool.

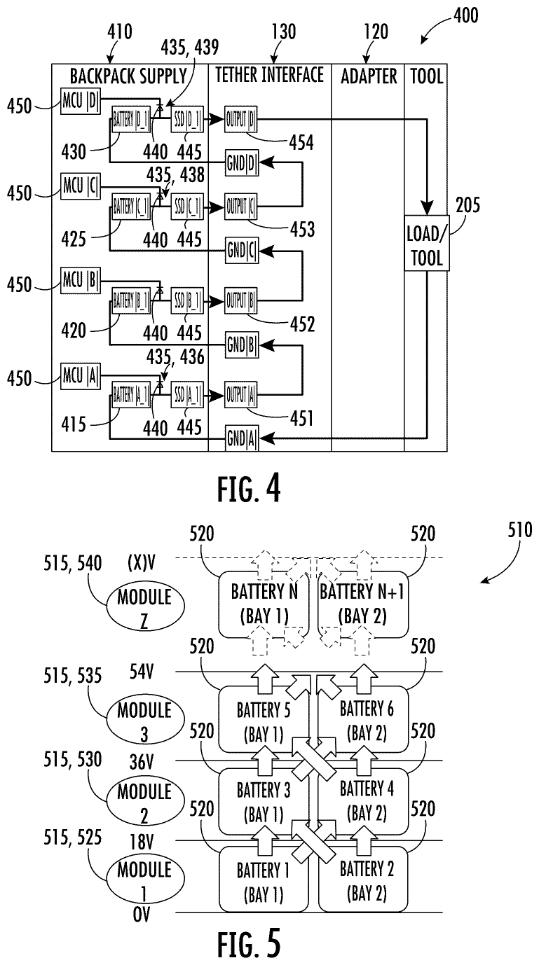

Referring now to FIG. 4, a schematic diagram of a system 400 for supplying power to the common load 205 in accordance with embodiments of the present disclosure is illustrated. In particular, as shown, the system 400 includes a battery pack 410. The battery pack 410 may include the power source(s) 105. For example, the battery pack 410 includes a plurality of batteries, such as a first battery 415, a second battery 420, a third battery 425, and a fourth battery 430. Each of the batteries 415, 420, 425, 430 are configured to be electrically coupled to the common load 205 via the tether interface 130 and the adapter(s) 120.

In at least one example embodiment, the battery pack 410 includes at least one control circuit 435 electrically coupled to each of the batteries 415, 420, 425, 430. The control circuit(s) 435 may include a first control circuit 436 electrically coupled to the first battery 415, a second control circuit 437 electrically coupled to the second battery 420, a third control circuit 438 electrically coupled to the third battery 425, and a fourth control circuit 439 electrically coupled to the fourth battery 430. In addition, as shown, each of the control circuits 436, 437, 438, 439 include a diode 440, a driver 445, and a controller 450. The driver 445 may be implemented with a solid state disconnect (SSD) controlled by the controller 450. In an embodiment, the controller 450 may be part of the controller(s) 110 discussed with respect to FIG. 1. Further, the controller 450 is configured to provide a signal to the driver 445 for controlling an output from one or more of the batteries 415, 420, 425, 430. For example, the controller 450 of each of the control circuits 436, 437, 438, 439 provides a signal to the driver 445 for controlling a first output 451 from the first battery 415, a second output 452 from the second battery 420, a third output 453 from the third battery 425, a fourth output 454 from the fourth battery 430, or a combination thereof.

However, it should also be understood that the controller 450 of one or more of the first control circuit 436, the second control circuit 437, the third control circuit 438, and the fourth control circuit 439 may be electrically coupled to one or more of the first battery 415, the second battery 420, the third battery 425, and the fourth battery 430 for controlling the output from one or more of the first battery 415, the second battery 420, the third battery 425, and the fourth battery 430. Accordingly, any of the first battery 415, the second battery 420, the third battery 425, and the fourth battery 430 may work with the controller 450 of any of the first control circuit 436, the second control circuit 437, the third control circuit 438, and the fourth control circuit 439.

Still referring to FIG. 4, the tether interface 130 is configured to arrange one or more of the batteries 415, 420, 425, 430 in series based on the voltage requirement of the common load 205. In at least one example embodiment, the adapter(s) 120 receives the common load 205 and the control circuit(s) 435 is configured to detect the voltage requirement of the common load 205 from the adapter(s) 120. The tether interface 130 is configured to connect one or more of the batteries 415, 420, 425, 430 in series based on the voltage requirement.

In at least one example embodiment, each of the batteries 415, 420, 425, 430 includes an 18-volt battery. In such embodiments, only one of the batteries 415, 420, 425, 430 would need to be connected to the common load 205 via the tether interface 130 and the adapter(s) 120 if the voltage requirement of the common load 205 is 18 volts. However, if the voltage requirement is 72 volts, all the batteries 415, 420, 425, 430 may be connected in series by the tether interface 130 to meet the voltage requirement of the common load 205, as shown in FIG. 4.

In other example embodiments, the voltage requirement of the common load may be 36 volts or 54 volts such that three or four of the batteries 415, 420, 425, 430, respectively, are connected in series by the tether interface 130 to meet the voltage requirement.

Referring now to FIG. 5, a schematic diagram of a battery pack 510 for supplying power to the common load 205 in accordance with embodiments of the present disclosure is illustrated. The battery pack 510 may be similar or analogous to the battery pack 410 discussed above with respect to FIG. 4.

In at least one example embodiment, as shown, the battery pack 510 includes a plurality of modules 515 for controlling a plurality of batteries 520. For example, each of the plurality of modules 515 may include two of the plurality of batteries 520, as shown. Moreover, additional modules and batteries may be added to the battery pack 510 to increase a voltage output of the battery pack 510. For example, the battery pack 510 may include a total of 1 to Z of the plurality of modules 515 and a total of 1 to N of the plurality of batteries 520.

In at least one example embodiment, the battery pack 510 includes at least a first module 525, a second module 530, and a third module 535. As discussed above with respect to FIG. 4, the plurality of batteries 520 of each module 515 may be connected in series or in parallel to achieve a desired voltage, such as the voltage requirement of the common load 205. For example, the battery pack 510 may output a voltage greater than or equal to 18 volts and less than or equal to 72 volts in some example embodiments. Moreover, the battery pack 510 may supply power to the common load 205. The common load 205 may be a power tool, such as one or more of an 18-volt power tool, a 36-volt power tool, and a 72-volt power tool.

In an exemplary embodiment, as shown, each of the plurality of batteries 520 may include 18-volt batteries. Accordingly, the first module 525 may output 18 volts; the first module 525 arranged in series with the second module 530 may output 36 volts; and the first module 525, the second module 530, and the third module 535 arranged in series may output 54 volts. However, as discussed above, additional modules may be added to the plurality of modules 515. For example, a fourth module 540 and so on may be added to the battery pack 510 such that the first module 525, the second module 530, the third module 535, and the fourth module 540 output 72 volts when arranged in series.

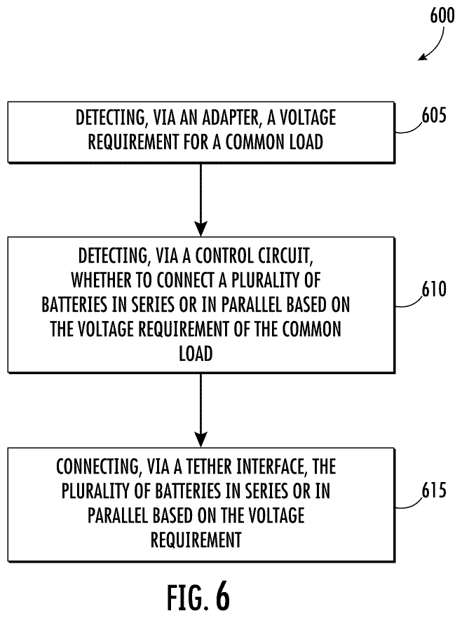

Referring now to FIG. 6, a flow diagram of a method 600 of supplying power to the common load 205 in accordance with embodiments of the present disclosure is illustrated. Such a method 600, for example, may be implemented by the battery pack of FIGS. 1-5. Further, the method 600 is illustrated as a collection of blocks in a logical flow chart, which represents operations that may be implemented in hardware, software, or combinations thereof. The order in which the method 600 is described is not intended to be construed as a limitation, and any number of the described blocks may be combined in any order to implement the exemplary method disclosed herein, or an equivalent alternative method. Additionally, certain blocks may be deleted from the exemplary method or augmented by additional blocks with added functionality without departing from the spirit and scope of the subject matter described herein.

In at least one example embodiment, as shown at (605), the method 600 includes detecting, via an adapter, a voltage requirement for a common load. As shown at (610), the method 600 includes determining, via a control circuit, whether to connect a plurality of batteries in parallel or in series based on the voltage requirement of the common load. For example, in an embodiment, determining whether to connect the plurality of batteries in parallel or in series based on the voltage requirement of the common load may include comparing the voltage requirement to a voltage threshold. As shown at (615), the method 600 includes connecting, via a tether interface, the plurality of batteries in series or in parallel based on the voltage requirement. In such embodiments, connecting the plurality of batteries in series or in parallel based on the voltage requirement may include connecting one or more of the plurality of batteries in series based on the voltage requirement exceeding the voltage threshold and/or connecting the plurality of batteries in parallel based on the voltage requirement being less than or equal to the voltage threshold. For example, the first power source 215 and the second power source 220 may be connected in series by the tether interface 130 based on the voltage requirement exceeding a voltage threshold, and the first power source 215 and the second power source 220 may be connected in parallel by the tether interface 130 based on the voltage requirement being less than or equal to the voltage threshold. In at least one example embodiment, the voltage threshold may be 18 volts.

In some additional example embodiments, connecting the plurality of batteries in series or in parallel based on the voltage requirement may include connecting one or more of the batteries 415, 420, 425, 430 in series via the tether interface 130 such that the voltage requirement is output to the common load 205. Additionally, or alternatively, connecting the plurality of batteries to the common load at 615 may include connecting one or more of the plurality of batteries 520 of the plurality of modules 515 in series via the tether interface 130 such that the voltage requirement is output to the common load 205. In at least one example embodiment, the voltage requirement is greater than or equal to 18 volts and less than or equal to 72 volts.

Further aspects of the disclosure are provided by one or more of the following embodiments:

A power pack configured to supply power to a common load is provided. The power pack includes a first power source; a second power source; at least one adapter configured to receive the common load and electrically couple the common load to at least one of the first power source or the second power source for supplying power to the common load; a tether interface electrically coupled to the at least one adapter, the first power source, and the second power source and configured to arrange the first power source and the second power source in series or in parallel; and a control circuit comprising at least one controller for performing a plurality of operations. The plurality of operations include detecting a voltage requirement of the common load from the at least one adapter, determining whether to connect the first power source or the second power source in series or in parallel based on the voltage requirement, connecting the first power source and the second power source in series via the tether interface when the voltage requirement exceeds a voltage threshold, and connecting the first power source and the second power source in parallel via the tether interface when the voltage requirement is less than or equal to the voltage threshold.

The power pack of any one or more of the embodiments, wherein the voltage threshold is 18 volts.

The power pack of any one or more of the embodiments, wherein the first power source comprises a first battery and a second battery; and the second power source comprises a third battery and a fourth battery.

The power pack of any one or more of the embodiments, wherein the at least one controller includes a first controller for controlling the power from at least one of the first battery or the second battery and a second controller for controlling the power from at least one of the third battery or the fourth battery.

The power pack of any one or more of the embodiments, wherein the control circuit further comprises a first driver communicably coupled to the first controller and a second driver communicably coupled to the second controller; the first driver is configured to control a first output of the first battery and the second battery; and the second driver is configured to control a second output of the third battery and the fourth battery.

The power pack of any one or more of the embodiments, wherein the first battery and the second battery are connected in parallel; and the third battery and the fourth battery are connected in parallel.

The power pack of any one or more of the embodiments, wherein the common load includes a power tool.

The power pack of any one or more of the embodiments, wherein the power tool includes one or more of an 18-volt power tool, a 36-volt power tool, or a 72-volt power tool.

The power pack of any one or more of the embodiments, wherein the power pack is configured to supply a range of voltages to the power tool; and the adapter is configured to prevent mechanical coupling to the power tool based on the voltage requirement of the power tool being outside the range of voltages.

The power pack of any one or more of the embodiments, further including a tether electrically coupling the tether interface and the at least one adapter, wherein the tether comprises a cable or wire.

A power pack configured to supply power to a common load is provided. The power pack includes a plurality of batteries; at least one adapter configured to receive the common load and electrically couple the common load to at least one of the plurality of batteries for supplying power to the common load; a tether interface electrically coupled between the at least one adapter and the plurality of batteries and configured to arrange one or more of the plurality of batteries in series; and a control circuit comprising at least one controller for performing a plurality of operations. The plurality of operations include detecting a voltage requirement of the common load from the at least one adapter, connecting at least two of the plurality of batteries in series via the tether interface based on the voltage requirement.

The power pack of any one or more of the embodiments, wherein each of the plurality of batteries include an 18-volt battery.

The power pack of any one or more of the embodiments, wherein the voltage requirement is greater than or equal to 18 volts and less than or equal to 72 volts.

The power pack of any one or more of the embodiments, wherein the at least one controller includes a controller for each of the plurality of batteries; and the control circuit further includes a driver communicably coupled to the controller for each of the plurality of batteries. The driver is configured to control an output from each of the plurality of batteries.

The power pack of any one or more of the embodiments, wherein the common load includes a power tool.

The power pack of any one or more of the embodiments, wherein the power tool includes one or more of an 18-volt power tool, a 36-volt power tool, and a 72-volt power tool.

The power pack of any one or more of the embodiments, further including a tether electrically coupling the tether interface and the adapter, and wherein the tether comprises a cable or wire.

A method of supplying power to a common load from a power pack is provided. The method includes detecting, via at least one adapter configured to receive the common load, a voltage requirement for the common load from the at least one adapter; determining, via a control circuit, whether to connect a plurality of batteries in parallel or in series based on the voltage requirement; and connecting, via a tether interface, the plurality of batteries in series or in parallel based on the voltage requirement.

The method of any one or more of the embodiments, further including connecting one or more of the plurality of batteries in series via the tether interface based on the voltage requirement exceeding a voltage threshold and connecting one or more of the plurality of batteries in parallel via the tether interface based on the voltage requirement being less than or equal to the voltage threshold. The voltage threshold is 18 volts.

The method of any one or more of the embodiments, wherein the voltage requirement is greater than or equal to 18 volts and less than or equal to 72 volts.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A power pack configured to supply power to a common load, the power pack comprising:
a first power source;
a second power source;
at least one adapter configured to receive the common load and electrically couple the common load to at least one of the first power source or the second power source for supplying power to the common load;
a tether interface electrically coupled to the at least one adapter, the first power source, and the second power source and configured to arrange the first power source and the second power source in series or in parallel; and
a control circuit comprising at least one controller for performing a plurality of operations, the plurality of operations comprising:
detecting a voltage requirement of the common load from the at least one adapter,
determining whether to connect the first power source or the second power source in series or in parallel based on the voltage requirement,
connecting the first power source and the second power source in series via the tether interface when the voltage requirement exceeds a voltage threshold, and
connecting the first power source and the second power source in parallel via the tether interface when the voltage requirement is less than or equal to the voltage threshold.

2. The power pack of claim 1, wherein the voltage threshold is 18 volts.

3. The power pack of claim 1, wherein:
the first power source comprises a first battery and a second battery; and
the second power source comprises a third battery and a fourth battery.

4. The power pack of claim 3, wherein the at least one controller comprises:
a first controller for controlling the power from at least one of the first battery or the second battery; and
a second controller for controlling the power from at least one of the third battery or the fourth battery.

5. The power pack of claim 4, wherein:
the control circuit further comprises a first driver communicably coupled to the first controller and a second driver communicably coupled to the second controller;
the first driver is configured to control a first output of the first battery and the second battery; and
the second driver is configured to control a second output of the third battery and the fourth battery.

6. The power pack of claim 3, wherein:
the first battery and the second battery are connected in parallel; and
the third battery and the fourth battery are connected in parallel.

7. The power pack of claim 1, wherein the common load comprises a power tool.

8. The power pack of claim 7, wherein the power tool comprises one or more of an 18-volt power tool, a 36-volt power tool, or a 72-volt power tool.

9. The power pack of claim 7, wherein:
the power pack is configured to supply a range of voltages to the power tool; and
wherein the adapter is configured to prevent mechanical coupling to the power tool based on the voltage requirement of the power tool being outside the range of voltages.

10. The power pack of claim 1, further comprising a tether electrically coupling the tether interface and the at least one adapter, wherein the tether comprises a cable or wire.

11. A power pack configured to supply power to a common load, the power pack comprising:
a plurality of batteries;
at least one adapter configured to receive the common load and electrically couple the common load to at least one of the plurality of batteries for supplying power to the common load;
a tether interface electrically coupled between the at least one adapter and the plurality of batteries and configured to arrange one or more of the plurality of batteries in series; and
a control circuit comprising at least one controller for performing a plurality of operations, the plurality of operations comprising:
detecting a voltage requirement of the common load from the at least one adapter,
connecting at least two of the plurality of batteries in series via the tether interface based on the voltage requirement.

12. The power pack of claim 11, wherein each of the plurality of batteries comprise an 18-volt battery.

13. The power pack of claim 11, wherein the voltage requirement is greater than or equal to 18 volts and less than or equal to 72 volts.

14. The power pack of claim 11, wherein:
the at least one controller comprises a controller for each of the plurality of batteries; and
the control circuit further comprises a driver communicably coupled to the controller for each of the plurality of batteries, the driver configured to control an output from each of the plurality of batteries.

15. The power pack of claim 11, wherein the common load comprises a power tool.

16. The power pack of claim 15, wherein the power tool comprises one or more of an 18-volt power tool, a 36-volt power tool, and a 72-volt power tool.

17. The power pack of claim 11, further comprising a tether electrically coupling the tether interface and the adapter, wherein the tether comprises a cable or wire.

18. A method of supplying power to a common load from a power pack, the method comprising:
detecting, via at least one adapter configured to receive the common load, a voltage requirement for the common load from the at least one adapter;
determining, via a control circuit, whether to connect a plurality of batteries in parallel or in series based on the voltage requirement; and
connecting, via a tether interface, the plurality of batteries in series or in parallel based on the voltage requirement.

19. The method of claim 18, further comprising:
connecting one or more of the plurality of batteries in series via the tether interface based on the voltage requirement exceeding a voltage threshold; and
connecting one or more of the plurality of batteries in parallel via the tether interface based on the voltage requirement being less than or equal to the voltage threshold;
wherein the voltage threshold is 18 volts.

20. The method of claim 18, wherein the voltage requirement is greater than or equal to 18 volts and less than or equal to 72 volts.
